(19) United States
(12) Patent Application Publication
(10) Pub. No.: US 2023/0182486 A1
(43) Pub. Date: Jun. 15, 2023

(54) DEVICE FOR IMPRINTING OR LABELLING CONTAINERS

(71) Applicant: KRONES AG, Neutraubling (DE)

(72) Inventors: Wolfgang ROIDL, Deuerling (DE); Hartmut DAVIDSON, Zeitlarn (DE); Michael NEUBAUER, Grassau (DE); Stefan SCHERL, Bernhardswald (DE); August PEUTL, Woerth a. d. Donau (DE); Heinrich BIELMEIER, Pilsting - Grosskoellnbach (DE)

(21) Appl. No.: 18/016,424

(22) PCT Filed: Jul. 22, 2021
(86) PCT No.: PCT/EP2021/070552

§ 371 Date: Jan. 16, 2023

(30) Foreign Application Priority Data
Jul. 31, 2020 (DE) 10 2020 120 290.3

(51) Int. Cl. B41J 3/407

(52) U.S. Cl. CPC B41J 3/40731; B41J 3/4075

(57) ABSTRACT

The invention relates to a device (10) for imprinting or labelling containers (12). The device (10) comprises a planar drive system (14) having a base element (16), a first movement device (18) and a second movement device (20). The first movement device (18) has a container holder (22) for holding a container (12). The second movement device (20) has a fitting device (24) for imprinting or labelling the container (12). The device (10) can improve a flexibility and a working quality during the imprinting and labelling of the containers (12).

### TECHNICAL FIELD

The invention relates to a device for imprinting or labelling containers.

### TECHNICAL BACKGROUND

Containers in different geometries and shapes are transported in filling and packaging installations through the individual system parts and, in the process, are filled, closed, labeled, inspected and transferred out, grouped and packaged.

The containers can have, for example, the following basic shapes: cylindrical, oval, rectangular, square or shaped irregularly. In addition, it is possible for the center points of the container base and the mouth to be offset with respect to the center axis (axis of rotation) of the container. This may have the result that, although the center axis is perpendicular, it is displaced, or that the center axis is inclined. In addition, the containers can sometimes have very large tolerances with respect to shape and position.

In the event of certain process steps with treatments undertaken on the container surface, it is advantageous if the treatment distance and the relative speed along the entire treatment section are as constant as possible.

For example, when imprinting containers, high and different printing distances lead to reduced printing quality due to droplet displacement. DE 10 2011 086 015 A1 describes a possibility for correcting different printing distances by controlling the ejection time of the droplets from the print head. It is described in DE 10 2013 217 669 A1 how a printing distance with a simultaneously constant printing speed can be compensated for within defined tolerance limits in the case of a linear machine or a carousel. It is conceivable that, on the basis of a theoretically known rotary plate curve, non-constant printing speeds (relative speed between container surface and print head) can be corrected in the activation of the ejection times of the droplets from the print head. The container surface which is not parallel to the print head or is perpendicular to the flight path of the droplets can be taken into consideration in such a manner that the ejection times of the droplets from the print head can be adjusted because the nozzles are distributed over a plurality of rows. Conventionally, container tolerances which change the printing distance are not determined and adjusted. In the event of a relatively large printing distance, more printing mist (“overspray”) arises by the fact that not all of the droplets reach the container surface because of their long flight path. This printing mist can be sucked off in order to avoid soiling the machine parts and the print head.

Similar problems may arise when labelling containers. In DE 10 2015 212 140 A1, a glue pattern is applied to a label using a glue printer. The printing result can be positively influenced here by moving past at a constant speed and constant distance.

Consecutive different process steps which may depend, inter alia, on container material or container format frequently require different movements or differ in the process times. This conventionally has the result that the longest process determines the entire sequence and therefore the capacity. Reference will be made by way of example to direct imprinting.

When a printed image is applied to a container, pinning can be undertaken between the application of the individual colors. Pinning, also called intermediate curing, controls the color profile by the period of time between color application and the intensity of the UV radiation being able to be varied. The period of time depends on the speed of the carousel. This in turn is predetermined by the geometry of the container. Greatly curved containers require a greater compensating movement of the container in front of the print head in order to minimize the printing distance. At the same time, however, the carousel speed also has to be reduced in order not to exceed the maximum, as far as possible constant printing speed=surface speed of the lateral surface to be imprinted on the container. Due to the different carousel speeds for different container shapes, different periods of time arise from the printing to the pinning. Further influencing factors on the period of time may be, inter alia, the container material, the state of the possibly additionally pretreated container surface, and the printing color. With regard to the printing color, each color may behave differently, e.g. the color white is generally, but not exclusively, applied first as a “primer” to the container material and the further colors are printed wet on wet. With regard to the application of color and the coverage, it should be noted that white conventionally has to be applied twice on two consecutive assemblies in order to achieve sufficient cover. The position of the pinning lamp may be adjusted to adjust the period of time.

A disadvantage in the prior art can be that different treatment distances and speeds at the container surface within the region to be treated may lead to a poor result because they cannot be compensated for due to kinematic restrictions. When imprinting containers, a compromise has to be found with the following factors: printing distance (container tolerances also increase the printing distance), printed image length, print quality, printing speed=>machine capacity, shape of the container. When imprinting containers, complex adjustment processes have to be worked with. At large printing distances, more printing mist arises. An additional outlay is incurred on sucking off and filtering the particles. In addition, ink is lost to waste. A double printing technique for the color white is required. In the event of printed images changing from batch size 1, the process cannot be optimally coordinated with each printed image because the printed images may mean that the time between pinning and printing is different.

With regard to the further prior art, reference is made to DE 10 2014 214 696 A1 which discloses a planar drive with movers which move containers, and process movers which move components from process stations.

The invention is based on the object of providing an alternative and/or improved device for imprinting or labelling containers.

### SUMMARY OF THE INVENTION

The object is achieved by the features of independent claim 1. Advantageous developments are specified in the dependent claims and the description.

One aspect of the present disclosure relates to a device for imprinting or labelling containers. The device has a planar drive system with a base element, a first movement device and a second movement device. The first movement device and the second movement device are movable independently from one another with respect to the base element by means of magnetic interaction with the base element. The first movement device has a container holder for holding a container. The second movement device has an equipping unit for imprinting or labelling the container.

The device advantageously provides improved flexibility when equipping containers. Different container diameters and container geometries (cylindrical, round, rectangular, freely shaped) can be flexibly equipped, i.e. labelled or imprinted, with the device. In addition, the device can expediently increase the working quality during the equipping because very flexible movements of the movement devices are permitted during the equipping, e.g. inclination, rotation and stroke movement. In particular, highly complex relative movements between the container and the equipping unit can also be made possible by the fact that both the first movement device and the second movement device are movable. Ultimately, even adaptation of the movements of the movement devices is permitted on an individual container basis, the adaptation being provided by means of the flexibility of the planar drive system and being able to further increase the working quality during the equipping operation.

In one exemplary embodiment, the planar drive system is configured (e.g. by means of a control unit) such that while the equipping unit of the second movement device imprints or labels the container held by the first movement device:
the first movement device at least temporarily moves and the second movement device is substantially at a standstill, or
the second movement device at least temporarily moves and the first movement device is substantially at a standstill; or
the first movement device at least temporarily moves and the second movement device at least temporarily moves.

In a further exemplary embodiment, the planar drive system is configured (e.g. by means of a control unit) such that while the equipping unit of the second movement device imprints or labels the container held by the first movement device, the first movement device and/or the second movement device are/is inclined with respect to the base element. Thus, for example, improved labelling or imprinting of oblique regions of the container can be achieved.

In a further exemplary embodiment, the planar drive system is configured (e.g. by means of a control unit) such that while the equipping unit of the second movement device imprints or labels the container held by the first movement device, the first movement device rotates about its own center axis and/or the second movement device rotates about its own center axis. Thus, for example, all-round labelling or a comparatively long printed image can be made possible.

In a further exemplary embodiment, the planar drive system is configured (e.g. by means of a control unit) such that while the equipping unit of the second movement device imprints or labels the container held by the first movement device, the first movement device and/or the second movement device carries out a stroke movement with respect to the base element. The container can therefore be brought as desired to a height position of a print head or of a label holder (e.g. label gripper, labeler pallet or label suction unit).

In one embodiment variant, the planar drive system is configured (e.g. by means of a control unit) such that while the equipping unit of the second movement device imprints or labels the container held by the first movement device, the first movement device at least partially bypasses, preferably circles around, the second movement device, or the second movement device at least partially bypasses, preferably circles around, the first movement device.

In a further exemplary embodiment, the planar drive system is configured (e.g. by means of a control unit) in order, while the equipping unit of the second movement device imprints or labels the container held by the first movement device, to carry out a relative movement, which is adapted to the respectively held container on an individual basis, between the first movement device and the second movement device. The relative movement is preferably adapted to an individual shape of a container surface of the container in the region of the container surface that is to be equipped, the container surface, for example, having been measured previously by a measuring unit. As already mentioned, the working quality during the imprinting or labelling can be significantly improved. In particular, even containers which have relatively large manufacturing tolerances can thus also be equipped with high working quality. The same applies, for example, for compensating for tolerances during the holding of the container by means of the container holder.

In a development, the relative movement is adapted in such a manner, that the container is guided past the equipping unit at a predetermined distance and/or at a predetermined surface speed. Alternatively or additionally, the relative movement is adapted depending on a, preferably previously detected, individual shape of the container and/or on a, preferably previously detected, individual size of the container. Alternatively or additionally, the relative movement has an individually determined movement path of the first movement device and/or of the second movement device, in which the container held by the first movement device is guided past the equipping unit at a substantially constant surface speed of the container, preferably a region of the container that is to be equipped, and/or at a substantially constant distance, preferably with respect to a region of the container that is to be equipped. Using the example of direct printing, by this means, for example, a higher printing quality can be achieved because of a smaller printing distance, less printing mist (waste) and a greater printed image length.

In one exemplary embodiment, the equipping unit is a labelling unit which is designed to label the container held by the second movement device. Alternatively, the equipping unit is a printing unit which is designed to imprint the container held by the second movement device.

In a further equipping example, a plurality of first movement devices are included, wherein preferably the plurality of first movement devices move in succession to the second movement device. Advantageously, a capacity of the device can thus be increased.

In one embodiment, the planar drive system has a further movement device with a measuring unit which is designed to measure the container held by the first movement device, preferably with respect to an individual shape (e.g. container surface, preferably in the region of the container surface that is to be equipped) and/or an individual size of the container.

Preferably, the relative movement between the first movement device and the second movement device can be determined on an individual container basis on the basis of measuring the container by means of the measuring unit.

It is possible for the further movement device and the first movement device to be moved relative to one another during the measuring, e.g. to be inclined, rotated, bypassed, circled around, raised or lowered.

In a further embodiment, the planar drive system has a further different movement device with a fixing unit which is designed to fix an imprint or a label on the container held by the first movement device.

In a development, the fixing unit is a curing unit which is designed to cure the imprint of the container held by the first movement device, preferably by means of UV light; or the fixing unit is a brush-on or roll-on sponge unit which is designed to brush on or to roll on the label of the container held by the first movement device.

In an embodiment variant, the planar drive system is configured (e.g. by means of a control unit) in order, while the fixing device of the further different movement device fixes the imprint or the label of the container held by the first movement device, to carry out a relative movement, which is adapted to the respectively held container on an individual container basis, between the first movement device and the further different movement device. Advantageously, the working quality during the fixing can thus likewise be significantly improved. In particular, even imprints or labels can thus be fixed on containers which have relatively great manufacturing tolerances, with a high degree of working quality. The same applies, for example, to the compensating of tolerances in the holding of the container by means of the container holder.

It is possible for the relative movement to be adapted in such a manner that the container is guided past the fixing unit at a predetermined distance and/or at a predetermined surface speed. Alternatively or additionally, the relative movement is adapted depending on a, preferably previously detected, individual shape (e.g. container surface, preferably in the region of the container surface that is to be equipped) of the container and/or on a, preferably previously detected, individual size of the container. Alternatively or additionally, the relative movement comprises an individually (on a container basis) determined movement path of the first movement device and/or of the further different movement device, during which the container held by the first movement device is guided past the fixing unit at a substantially constant surface speed of the container, preferably of the region of the container that is to be equipped, and/or at a substantially constant distance, preferably with respect to the region that is to be equipped.

In a further embodiment variant, the planar drive system is configured (e.g. by means of a control unit) in order to adapt a speed of the first movement device to the equipping undertaken by the equipping unit, preferably to the imprint (e.g. width, length, position and/or color) during the movement of the second movement device with respect to the further different movement device. Therefore, for example, a drying time to the intermediate curing can be flexibly adapted to the respective imprint.

For example, the base element can be oriented horizontally. The base element can preferably be substantially frame-shaped, rectangular, circular or annular. In principle, the base element can therefore be adapted to different system layouts and construction space conditions.

Preferably, the movement devices can be supported contactlessly by the base element, preferably on an upper side of the base element, by means of magnetic interaction.

The device as disclosed herein can preferably be used in a container processing system (e.g. for producing, cleaning, checking, filling, closing, labelling, imprinting and/or packaging containers for liquid media, preferably beverages or liquid foodstuffs).

Preferably, the term “control unit” can refer to an electronic unit (e.g. with microprocessor(s) and data memory) which can perform open-loop control tasks and/or closed-loop control tasks and/or processing tasks, depending on the design. Even if the term “control” is used herein, it can usefully include or mean “closed-loop control” or “open-loop control with feedback” and “processing”.

The preferred embodiments and features of the invention which are described above can be combined with one another as desired.

The labelling can comprise decorating, for example attaching bows to a bottleneck, attaching metal strips, etc.

### BRIEF DESCRIPTION OF THE FIGURES

Further details and advantages of the invention are described below with reference to the attached drawings, in which:

FIG. 1 shows a perspective schematic illustration of a device for imprinting or labelling a container according to an exemplary embodiment of the present disclosure; and

FIG. 2 shows a schematic top view of a device for imprinting or labeling a container according to a further exemplary embodiment of the present disclosure, with the movement path of the container being depicted.

The embodiments shown in the figures are at least partially identical, and therefore similar or identical parts are provided with the same reference signs, and reference is also made, for their explanation, to the description of the other embodiments or figures in order to avoid repetition.

### DETAILED DESCRIPTION OF EXEMPLARY EMBODIMENTS

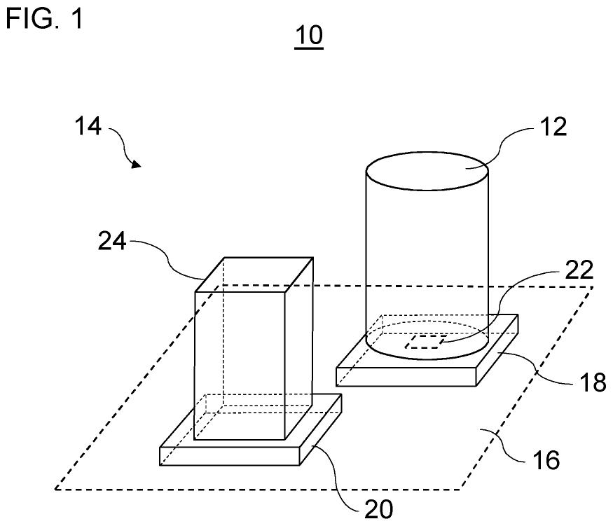

FIG. 1 shows a device 10 for imprinting or labelling containers 12, e.g. bottles (glass bottles, PET bottles, etc.), cans, etc. The device 10 has a planar drive system 14.

The planar drive system 14 has a base element 16 and a plurality of movement devices (movers or runners) 18, 20. The movement devices 18, 20 can be moved freely and independently of one another over the base element 16 by means of magnetic interaction with the base element 16. The movement devices 18, 20 can also be rotated with respect to the base element 16 (e.g. swiveling) by means of magnetic interaction with the base element 16. The movement devices 18, 20 can also be inclined with respect to the base element 16 (e.g. pitching and/or rolling) by means of magnetic interaction with the base element 16. The movement devices 18, 20 can likewise perform a stroke movement upward or downward relative to the base element 16 by means of magnetic interaction with the base element 16. A number of the movement devices 18, 20 can be freely selectable, depending on the application.

The base element 16 forms a stator of the planar drive system 14. The movement devices 18, 20 form runners of the planar drive system 14. The movement devices 18, 20 are supported contactlessly by the base element 16, preferably on an upper side of the base element 16. The base element 16 can have, for example, a plurality of electromagnets arranged in a distributed manner, e.g. electric coils. The movement devices 18, 20 can have permanent magnets. The electromagnets are preferably arranged in a matrix which extends in a plane of the base element 16 (here preferably a horizontal plane). A control unit (not illustrated) of the planar drive system 14 can control a power supply to the electromagnets of the base element 16 in order to build up electromagnetic fields with a desired field strength at a desired position of the base element 16. Forward propulsion, rotation, inclination and/or a stroke of the movement devices 18, 20 can be brought about by corresponding electromagnetic fields of the electromagnets of the base element 16. The base element 16 is preferably oriented in a horizontal plane. However, other orientations are also conceivable, e.g. a vertical orientation.

The plurality of movement devices 18, 20 comprise at least a first movement device 18 and a second movement device 20.

The first movement device 18 supports a container holder 22 (merely indicated schematically in FIG. 1). The container holder 22 is designed to hold the container 12 (or else a plurality of containers 12). For example, the container holder 22 can be embodied as a gripper, a clamping holder, a suction holder or in some other way (with or without an actuator system). The first movement device 18 can therefore move the container 12 held by means of the container holder 22 freely over a surface of the base element.

The second movement device 20 supports an equipping unit 24 for imprinting or labelling the container 12. Depending on design, the equipping unit 24 can be, for example, a labelling unit or a printing unit.

The labelling unit can label the container 12 held by the first movement device 18. For example, cold glue labels, hot glue labels, self-adhesive labels or sleeve labels can be applied by the labelling unit.

The printing unit can imprint the container 12 held by the first movement device 18. For example, the printing unit can use a direct printing method. The ink used by the printing unit may be curable by means of UV radiation, for example.

Preferably, the first movement device 18 and the second movement device 20 move at least temporarily relative to each other while the equipping unit 24 equips the container 12 with an imprint or a label. For example, the two movement devices 18, 20 or only one of the movement devices 18 or 20 can move in the process. The movement of the movement device 18 and/or 20 can comprise, for example, an inclination with respect to the base element 16, rotation about its own center axis and/or a stroke movement with respect to the base element 16. Alternatively or additionally, the movement of the movement device 18 or 20 can comprise bypassing, preferably circling around, the respectively other movement device 20 or 18.

In order to improve the equipping, that is to say the labelling or the imprinting, of the container 12, the relative movement between the movement devices 18 and 20 during the equipping operation can be adapted to the respective container 12 on an individual basis. Before the equipping operation, the container 12 can be measured individually with respect to shape and/or size, in particular with respect to the region that is to be equipped of the container 12. In the process, for example, precise measurements of the container 12 within the manufacturing tolerances thereof can also be detected. The relative movement between the movement devices 18, 20 can be adapted to the individual shape and/or size (of containers) in such a manner that the container 12 is guided at a predetermined distance and/or at a predetermined surface speed past the equipping unit for labelling or imprinting the container 12. Preferably, for the relative movement, a movement path of the first movement device 18 and/or of the second movement device 20 can be determined, preferably calculated, on an individual (container) basis. Said movement path is determined in such a manner that the container 12 is guided past the equipping unit 24 at a substantially constant surface speed of the container 12, in particular with respect to the region that is to be equipped and/or at a substantially constant distance. As a result, a printed image or labelling of the container 12 can be significantly improved.

It is possible for the planar drive system 14 to have further movement devices with application apparatuses for processing or checking the container 12 held by the first movement device 18. The further movement devices can otherwise be constructed in the same way as the first and second movement devices 18, 20. A relative movement between the further movement device and the first movement device 18 can be controlled especially by the planar drive system 14, in particular on an individual (container) basis, in the same way as the relative movement between the first and second movement devices 18, 20.

The application apparatuses of the further movement devices can preferably have a measuring unit, a fixing unit and/or a further equipping unit.

The measuring unit can measure the container 12 held by the first movement device 18. For example, a size, a surface shape, a diameter, a width and/or a height of the container 12 can be measured by means of the measuring unit. The measuring unit preferably operates with a contactless measuring principle, e.g. optically with a camera, a laser scanner or an LED scanner, or acoustically by means of sound, preferably ultrasound. It is also possible for the measuring unit to use another or additional measuring principle, e.g. a tactile measurement by means of a measuring probe which is moved over a surface of the container.

The fixing unit can be designed as an imprint fixing unit (curing unit or pinning unit). The curing unit can cure or pin an imprint on the container 12 held by the first movement device 18. For this purpose, the curing unit can have, for example, a UV lamp with which the ink of the imprint can be cured.

The fixing unit can alternatively be designed as a label fixing unit with a brush or a roll-on sponge. The label fixing unit can fix and smooth a label on the container 12 held by the first movement device 18 by brushing or rolling it on.

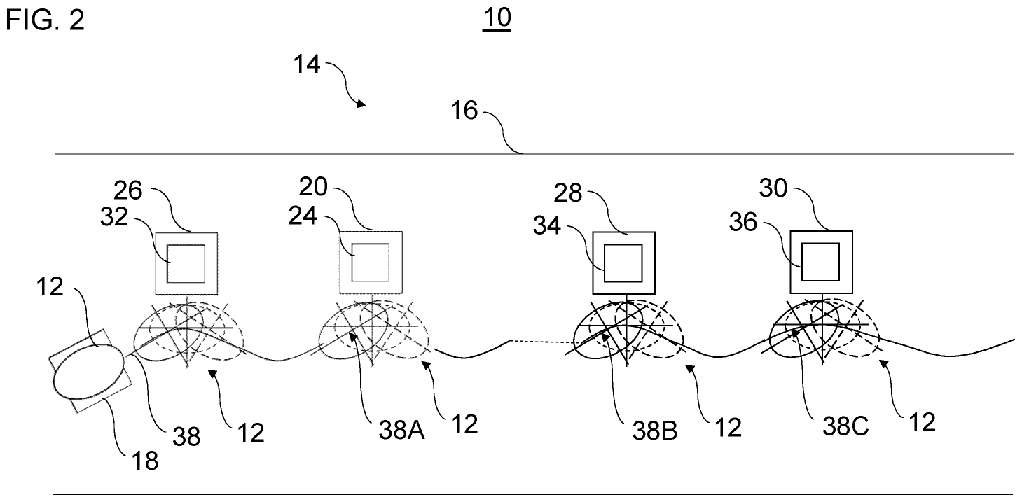

FIG. 2 shows a planar drive system 14 in which a first movement device 18 (for better clarity only illustrated once at the outset) moves the container 12 to a plurality of movement devices 20, 26, 28, 30.

The second movement device 20 has the equipping unit 24 which is designed as an imprinting unit. The movement device 26 has the measuring unit 32. The movement device 28 has the fixing unit 34 which is designed as a curing unit. The movement device 30 has a further equipping unit 36 which is likewise designed as an imprinting unit.

The first movement device 18 with the container 12 moves along a trajectory 38 (illustrated in exaggerated form) in succession to the movement device 26 with the measuring unit 32, to the second movement device 20 with the equipping unit 24, to the movement device 28 with the fixing unit 34 and to the movement device 30 with the equipping unit 36. A relative movement is in each case performed between the first movement device 18, on the one hand, and the measuring unit 32, the equipping unit 24, the fixing unit 34 and the equipping unit 36.

The measuring unit 32 measures the container 12 individually with respect to shape, in particular surface shape, and size while the container 12 is being moved along the measuring unit 32. The measuring unit 32 measures in particular a portion of the container 12 that is subsequently equipped (=“region that is to be equipped”) by the equipping unit 24. On the basis of the measurement of the measuring unit 32, a movement path 38A is determined, preferably calculated, for the first movement device 18 in such a manner that the container 12 during movement past the equipping unit 24 is moved at the constant distance, which is preferably as small as possible, and at the constant surface speed of that portion of the container 12 that is to be equipped is moved along the equipment unit 36.

As already mentioned, the movement path 38A could alternatively or additionally also be determined for the second movement device 20. It goes without saying that the movement path 38A which is illustrated is purely by way of example and, for example, may also be designed differently, for example as an oscillating movement or as a rotating movement in front of each equipping unit about the container axis in the case of cylindrical containers.

The planar drive system 14 then moves the first movement device 18 along the equipping unit 24 in accordance with the individually (on a container basis) determined movement path 38A while the equipping unit 24 imprints the container 12. After the imprinting, the first movement device 18 is moved further to the movement device 28 with the fixing unit 34. During the movement of the first movement device 18 to the fixing unit 34, a speed of the first movement device 18 can be adapted in order to ensure that a predetermined period of time elapses between the printing and the curing. Preferably, the speed of the first movement device 18 is adapted here individually to the imprint of the container 12 performed by means of the equipping unit 24. The first movement device 18 is moved in accordance with a movement path 38B along the movement device 28 or the fixing unit 34 during the curing/pinning of the imprint of the container 12. The movement path 38B can correspond to the movement path 38A or can be determined in a similar way with additional dependency on a configuration of the fixing unit 34.

After the fixing, the first movement device 18 can optionally also be moved to the movement device 30 with the equipping unit 36 in order to further imprint the container 12 (for example for a multi-colored imprint). During the equipping operation, the first movement device 18 can move along the movement path 38C which corresponds to the movement path 38A or can be determined in a similar manner with additional dependency on a configuration of the equipping unit 36.

By means of the possibility of inclining the movement devices 18, 20 and/or 30 with respect to the base element 16, oblique surfaces of the container 12 can also be imprinted by means of the equipping unit 24 and/or 36. By adaptation of the stroke of the movement devices 18, 20 and/or 30, an orientation at the height of the print heads of the equipping units 24, 36 is possible so that, for example, the droplets ejected by the print heads can be correctly placed from color to color. In principle, different primers and colors can be applied to the container 12 by different printing units approaching it.

The use example described with respect to FIG. 2 can also be used analogously for the labelling of containers 12. In this case, the movement path which is determined can be, for example, rotation of the first movement device 18 for all-round labelling or an oscillating movement for (cold) glue labelling by means of the equipping unit 24 designed as a labelling unit.

The invention is not restricted to the preferred exemplary embodiments described above. On the contrary, a large number of variants and modifications is possible which likewise make use of the concept of the invention and therefore fall within the scope of protection.

In particular, the invention also claims protection for the subject matter and the features of the dependent claims independently of the claims referred to. In particular, the individual features of independent claim 1 are each disclosed independently of one another. In addition, the features of the dependent claims are also disclosed independently of all of the features of independent claim 1 and, for example, independently of the features relating to the presence and/or configuration of the planar drive system, the first movement device and/or of the second movement device of independent claim 1.

### LIST OF REFERENCE SIGNS

10 Device for imprinting or labelling containers
12 Container
14 Planar drive system
16 Base element
18 First movement device
20 Second movement device
22 Container holder
24 Equipping unit
26 Movement device
28 Movement device
30 Movement device
32 Measuring unit
34 Fixing unit
36 Equipping unit
38 Trajectory
38A Adapted movement path
38b Adapted movement path
38C Adapted movement path

1. A device for imprinting or labelling containers, comprising:
a planar drive system comprising a base element, a first movement device and a second movement device, wherein the first movement device and the second movement device are movable independently of one another with respect to the base element using magnetic interaction with the base element,
wherein:
the first movement device comprises a container holder for holding a container; and
the second movement device comprises an equipping unit for imprinting or labelling the container.

2. The device as claimed in claim 1, wherein:
the planar drive system is configured such that while the equipping unit of the second movement device imprints or labels the container held by the first movement device:
the first movement device at least temporarily moves and the second movement device is substantially at a standstill, or
the second movement device at least temporarily moves and the first movement device is substantially at a standstill; or
the first movement device at least temporarily moves and the second movement device at least temporarily moves.

3. The device as claimed in claim 1, wherein:
the planar drive system is configured such that while the equipping unit of the second movement device imprints or labels the container held by the first movement device:
the first movement device and/or the second movement device is inclined with respect to the base element; and/or
the first movement device rotates about its own center axis and/or the second movement device rotates about its own center axis; and/or
the first movement device and/or the second movement device performs a stroke movement with respect to the base element.

4. The device as claimed in claim 1, wherein:
the planar drive system is configured such that while the equipping unit of the second movement device imprints or labels the container held by the first movement device:
the first movement device at least partially bypasses the second movement device; or
the second movement device at least partially bypasses the first movement device.

5. The device as claimed in claim 1, wherein:
the planar drive system is configured in order, while the equipping unit of the second movement device imprints or labels the container held by the first movement device, to carry out a relative movement, which is configured to the respectively held container on an individual container basis, between the first movement device and the second movement device.

6. The device as claimed in claim 5, wherein:
the relative movement is configured in such a manner that the container is guided past the equipping at a predetermined distance and/or at a predetermined surface speed.

7. The device as claimed in claim 5, wherein:
the relative movement is configured depending on an individual shape of the container and/or on an individual size of the container.

8. The device as claimed in claim 5, wherein:
the relative movement has an individually, on a container basis, determined movement path of the first movement device and/or of the second movement device, in which the container held by the first movement device is guided past the equipping unit at a substantially constant surface speed of the container and/or at a substantially constant distance that is to be equipped.

9. The device as claimed in claim 1, wherein:
the equipping unit is a labelling unit which is designed to label the container held by the second movement device, or
the equipping unit is a printing unit which is designed to imprint the container held by the second movement device.

10. The device as claimed in claim 1, wherein:
a plurality of first movement devices are included.

11. The device as claimed in claim 1, wherein:
the planar drive system further comprises a further movement device with a measuring unit which is designed to measure the container held by the first movement device.

12. The device as claimed in claim 1, wherein:
the planar drive system further comprises a further different movement device with a fixing unit which is designed to fix an imprint or a label on the container held by the first movement device.

13. The device as claimed in claim 12, wherein:
the fixing unit is a curing unit which is designed to cure the imprint of the container held by the first movement device; or
the fixing unit is a brush-on or roll-on sponge unit which is designed to brush on or to roll on the label of the container held by the first movement device.

14. The device as claimed in claim 12, wherein:
the planar drive system is configured in order, while the fixing unit of the further different movement device fixes the imprint or the label of the container ) held by the first movement device, to carry out a relative movement, which is configured to the respectively held container on an individual basis, between the first movement device and the further different movement device.

15. The device as claimed in claim 12, wherein:
the planar drive system is configured to adapt a speed of the first movement device to the equipping undertaken by the equipping unit during the movement from the second movement device to the further different movement device.

16. The device as claimed in claim 1, wherein:
the planar drive system is configured such that while the equipping unit of the second movement device imprints or labels the container held by the first movement device:
the first movement device at least partially bypasses and circles around the second movement device; or
the second movement device at least partially bypasses and circles around the first movement device.

17. The device as claimed in claim 1, wherein the planar drive system is configured in order, while the equipping unit of the second movement device imprints or labels the container held by the first movement device, to carry out a relative movement, which is configured to the respectively held container on an individual container basis, between the first movement device and the second movement device, and the relative movement is configured to an individual shape of a container surface of the container in a region of the container surface that is to be equipped.

18. The device as claimed in claim 5, wherein the relative movement is configured depending on a previously detected individual shape of the container and/or on a previously detected individual size of the container.

19. The device as claimed in claim 5, wherein:
the relative movement has an individually, on a container basis, determined movement path of the first movement device and/or of the second movement device, in which the container held by the first movement device is guided past the equipping unit at a substantially constant surface speed of a region of the container that is to be equipped, and/or at a substantially constant distance with respect to a region of the container that is to be equipped.

20. The device as claimed in claim 1, wherein:
a plurality of first movement devices are included, wherein the plurality of first movement devices move in succession to the second movement device.

21. The device as claimed in claim 1, wherein:
the planar drive system further comprises a further movement device with a measuring unit which is designed to measure the container held by the first movement device with respect to an individual shape and/or an individual size of the container.

22. The device as claimed in claim 12, wherein:
the fixing unit is a curing unit which is designed to cure the imprint of the container held by the first movement device using UV light; or
the fixing unit is a brush-on or roll-on sponge unit which is designed to brush on or to roll on the label of the container held by the first movement device.

23. The device as claimed in claim 12, wherein:
the planar drive system is configured to adapt a speed of the first movement device to the equipping undertaken by the equipping unit during the movement from the second movement device to the further different movement device.
